(19) United States
(12) Patent Application Publication
(10) Pub. No.: US 2008/0156385 A1
(43) Pub. Date: Jul. 3, 2008

(54) Baffle System For Use In An Air Conditioning Unit, In Particular An Aircraft Air Conditioning Unit

(75) Inventors: Thomas Treimer, Laupheim (DE); Mario Miebach, Laupheim (DE); Alfred Huber, Apfingen (DE)

Correspondence Address: WOOD, HERRON & EVANS, LLP, 2700 CAREW TOWER, 441 VINE STREET, CINCINNATI, OH, 45202, US

(73) Assignee: Airbus Deutschland GmbH, Hamburg (DE)

(21) Appl. No.: 11/968,480

(22) Filed: Jan. 2, 2008

Related U.S. Application Data
(60) Provisional application No. 60/883,179, filed on Jan. 3, 2007.

(30) Foreign Application Priority Data
Jan. 3, 2007 (DE) DE102007001052.6

(51) Int. Cl. F15D 1/02

(52) U.S. Cl. 138/37; 138/39

(57) ABSTRACT

A baffle system (14) for use in an air conditioning unit, in particular an aircraft air conditioning unit, comprises a baffle frame (22) that is attachable to an open end (12) of a pipeline (10) of the air conditioning unit and a baffle (16) that defines a flow cross-section of the pipeline (10). A receiving groove (24, 64) is formed on the baffle frame (22) and/or the baffle (16) which extends over only a portion of the circumference of the baffle frame (22) and/or the baffle (16). The baffle (16) is insertable into the receiving groove (24) formed on the baffle frame (22), and/or a first guide web (28) formed on the baffle frame (22) is insertable into the receiving groove (64) formed on the baffle (16).

The present invention relates to a baffle system for use in an air conditioning unit, in particular an aircraft air conditioning unit, and to an aircraft air conditioning unit that is equipped with a baffle system of this kind.

Air conditioning units that are currently used in aircraft, in particular in passenger aircraft, comprise a large number of pipelines, such as recirculation lines, fresh air lines, exhaust air lines, etc. The volume flow through these pipelines and the pressure in these pipelines are regulated using baffles which are introduced into the pipelines to adjust a desired flow cross-section.

A known baffle that is suitable for use in an aircraft air conditioning unit conventionally comprises a plurality of fastening flanges which are distributed over the circumference of the baffle and which, when the baffle is assembled, rest on an inner circumference of the pipeline and to secure the baffle in the pipeline are riveted to the pipeline wall. Assembly of a baffle of this kind is labour-, time- and therewith cost-intensive. This is particularly disadvantageous if the baffle has to be replaced, for example during calibration to adjust the desired volume flow flowing through the pipeline or the desired pressure that exists in the pipeline. Furthermore, the rivet holes formed in the pipeline wall lead to weakening of the pipeline.

The present invention is directed toward the object of providing a baffle system that can be assembled quickly, simply and safely and that is suitable for use in an air conditioning unit, in particular an aircraft air conditioning unit, and providing an aircraft air conditioning unit equipped with a baffle system of this kind.

This object is achieved by a baffle system with the features recited in claim 1 and by an aircraft air conditioning unit with the features recited in claim 14.

The baffle system according to the invention intended for use in an air conditioning unit, in particular an aircraft air conditioning unit, comprises a baffle frame which is attachable to an open end of a pipeline of the aircraft air conditioning unit. The open end of the pipeline can be adapted to not to be connected to a further pipeline. Alternatively the open end of the pipeline can, however, also be intended for connection to a further pipeline. The pipeline can for example be a recirculation line, a fresh air line, an exhaust air line or any other desired pipeline of the aircraft air conditioning unit.

The baffle system according to the invention also comprises a preferably disc-shaped baffle that defines a flow cross-section of the pipeline. The shape of the baffle frame and the baffle are preferably adapted to the cross-section of the pipeline. A circular baffle can be used for example for a pipeline with a circular cross-section and an oval baffle for an oval pipe cross-section. The baffle is moreover preferably constructed in such a way that a desired flow cross-section is adjusted in the pipeline and therewith a desired volume flow through the pipeline and a desired pressure in the pipeline. Alternatively or additionally the baffle can be used for acoustic damping. The baffle can therefore have only one through-flow opening but can also have a plurality of is through-flow openings.

In a first embodiment of the baffle system according to the invention a receiving groove is formed on the baffle frame which extends over only a portion of the circumference of the baffle frame. The baffle is then shaped in such a way that it is insertable into the receiving groove formed on the baffle frame. The thickness of the baffle in particular is adapted to the shape of the receiving groove formed on the baffle frame.

In a second embodiment of the baffle system according to the invention a receiving groove is formed on the baffle and extends over only a portion of the circumference of the baffle. A first guide web is then formed on the baffle frame which is insertable into the receiving groove formed on the baffle. For example the first guide web formed on the baffle frame extends radially outwards from an outer circumference of the pipeline when the baffle frame is assembled on the pipeline.

In a third embodiment of the baffle system according to the invention a receiving groove is formed on the baffle frame and on the baffle and extends over only a portion of the circumference of the baffle frame or the baffle. In this case, when the baffle system is assembled on the pipeline, the receiving groove formed on the baffle frame extends along a portion of the circumference of the pipeline in which the baffle is not provided with a receiving groove. Conversely, when the baffle system is assembled on the pipeline, the receiving groove formed on the baffle is provided along a portion of the circumference of the pipeline in which the baffle frame does not have a receiving groove. The baffle then is insertable into the receiving groove formed on the baffle frame. At the same time a first guide web which is formed on the baffle frame and extends radially outwards, for example from an outer circumference of the pipeline, when the baffle frame is assembled on the pipeline, is insertable into the receiving groove formed on the baffle.

During assembly of the baffle system according to the invention firstly the baffle frame is secured to the pipeline. The baffle is subsequently pushed onto the baffle frame, wherein the baffle and/or the first guide web formed on the baffle frame is received in the receiving groove formed on the baffle frame and/or baffle. The baffle system according to the invention can therefore be assembled particularly easily and simply, and therewith inexpensively, on the pipeline of the aircraft air conditioning unit. The baffle is moreover easy to replace if, for example, during calibration for adjustment of the desired volume flow flowing through the pipeline or the desired pressure that exists in the pipeline, it turns out that the baffle is not suitable for achieving the desired flow or pressure conditions in the pipeline or for achieving the desired acoustic damping and has to be replaced by a different baffle. Finally, when using the baffle system according to the invention the introduction of rivet holes into the pipeline can be dispensed with, so the mechanical properties of the pipeline are not affected by the attachment of the baffle system on the pipeline. The baffle system according to the invention is therefore also advantageous from safety requirement perspectives.

The baffle frame of the baffle system according to the invention preferably comprises a fastening region that is adapted to a cross-section of the pipeline and which extends substantially parallel to a pipeline wall when the baffle frame is assembled on the pipeline. When the baffle system is assembled on the pipeline the fastening region of the baffle frame preferably rests on an outer circumference or an inner circumference of the pipeline. The baffle frame can then be fastened particularly simply, securely and conveniently to the pipeline by producing a glued joint between the fastening region and the pipeline. The fastening region of the baffle frame is preferably constructed in such a way that when the baffle frame is assembled on the pipeline it extends over the entire outer circumference or inner circumference of the pipeline. This allows particularly secure fastening of the baffle frame to the pipeline. Alternatively it is also possible, however, to provide the baffle frame with a fastening region which, when the baffle frame is assembled on the pipeline, extends over only a portion of the outer circumference or inner circumference of the pipeline. For example the fastening region of the baffle frame can also have a U-shaped cross-section.

The receiving groove formed on the baffle frame is preferably formed by the first guide web of the baffle framer a second guide web arranged substantially parallel to the first guide web, and a connecting web connecting the first guide web to the second guide web. The first and second guide webs of the baffle frame preferably extend substantially perpendicular to the fastening region, the connecting web on the other hand preferably extends substantially parallel to the fastening region.

The second guide web and the connecting web of the baffle frame preferably extend over only a portion of the circumference of the baffle frame. The first guide web of the baffle frame by contrast preferably extends over the entire circumference of the baffle frame. The baffle can then easily be pushed into the receiving groove, which is formed on the baffle frame by the first and second guide webs and the connecting web of the baffle frame. At the same time the first guide web of the baffle frame, which extends over the entire circumference of the baffle frame, forms a bearing surface for the baffle, so that secure positioning of the baffle in the baffle frame is possible. If the baffle is also provided with a receiving groove the first guide web of the baffle frame is also received in the receiving groove formed on the baffle when the baffle is assembled on the baffle frame, whereby optimum positioning of the baffle in the baffle frame is ensured.

In a preferred embodiment of the baffle system according to the invention the receiving groove formed on the baffle is formed by a first guide web that extends radially outwards from a baffle face, a second guide web arranged substantially parallel to the first guide web, and a connecting web connecting the first guide web to the second guide web. The first and second guide webs and the connecting web of the baffle preferably extend over only a portion of the circumference of the baffle.

If the baffle system according to the invention is provided at an open end of a pipeline, which is connected to a further pipeline, the baffle is preferably fastened in its position in the baffle frame by the connecting mechanism that is also used to connect the two pipelines. A conventional pipe collar or the like may be used as the connecting mechanism which satisfies a dual function of connecting the two pipelines together and of fastening the baffle in its position in the baffle frame. An arrangement of this kind has the advantage that the baffle can be particularly easily assembled and disassembled and consequently can also be replaced particularly quickly if required.

If the open end of the pipeline, on which the baffle system according to the invention is attached, on the other hand is not connected to a further pipeline, the baffle and/or the baffle frame is/are preferably equipped with a self-locking mechanism for fastening the baffle in the baffle frame. An additional fastening device, such as a pipe collar or the like that surrounds the baffle frame and the baffle can then advantageously be omitted.

The self-locking mechanism can for example comprise at least one elastic latching arm which is formed on the baffle and which is constructed to latch with the first or the second guide web of the baffle frame when the baffle is assembled in the baffle frame. The first and/or the second guide web of the baffle frame preferably has a section that projects radially inwards and a section that projects radially outwards with respect to the fastening region of the baffle frame. The elastic latching arm formed on the baffle then encompasses the first or the second guide web of the baffle frame when the baffle is inserted in the receiving groove formed on the baffle frame and holds the baffle in its position in the baffle frame by its interlocking connection. There is preferably a plurality of latching arms to ensure secure fastening of the baffle in the baffle frame.

In an alternative embodiment of the baffle system according to the invention the self-locking mechanism can also comprise at least one elastic latching arm formed on the baffle frame. This latching arm can for example be provided to latch with the baffle or a first or second guide web formed on the baffle when the baffle is assembled in the baffle frame. It is understood that a plurality of elastic latching arms may also be provided on the baffle frame.

The baffle and/or the baffle frame is/are preferably made from a plastics material. The elastic latching arm(s) then can be formed in a simple manner from the same material as the baffle or baffle frame and be moulded to the baffle or baffle frame.

The self-locking mechanism preferably also comprises a positioning pin that is formed on the baffle and is constructed to cooperate with an opening formed in the first or second guide web of the baffle frame. The opening can be formed in an extension which extends radially inwards from the first or second guide web of the baffle frame, Cooperation of the positioning pin formed on the baffle with the opening formed on the baffle frame ensures correct positioning of the baffle in the baffle frame. It is understood that the positioning pin can also be formed on the baffle frame and cooperate with an opening formed on the baffle.

Alternatively or additionally the self-locking mechanism can also comprise at least one elastic latching button which is formed on the baffle and which is constructed to latch in a latching opening formed on the baffle frame. The latching button can for example comprise one or more elastic latching arms. The baffle can be securely fastened in the baffle frame by a latching mechanism of this kind. Correct positioning of the baffle in the baffle frame is ensured at the same time.

In an alternative embodiment of the baffle system according to the invention the self-locking mechanism comprises a baffle flange section that extends over a portion of the circumference of the baffle, and at least one elastic holding arm that extends from the baffle flange section. The baffle flange section preferably extends substantially perpendicularly to the baffle face of the disc-shaped baffle and when the baffle system according to the invention is assembled on the pipeline rests on an outer wall of the pipeline. The elastic holding arm is configured in such a way that it encompasses the pipe and holds the baffle in its position in the baffle frame owing to its spring effect. The self-locking mechanism preferably comprises two holding arms which extend from the baffle flange section from two mutually opposing sides of the baffle flange section.

In a particularly preferred embodiment of the baffle system according to the invention the baffle is constructed in such a way that it can be used to define the flow cross-section of two mutually adjacent pipes of the pipeline. The use of a baffle of this kind is not limited to the baffle system according to the invention Instead the baffle described hereinafter may also be used independently of the baffle frame of the baffle system according to the invention and for example be conventionally fastened in the pipeline by riveting. In particular, the baffle comprises a first baffle section that defines a flow cross-section of a first pipe of the pipeline, and a second baffle section that defines a flow cross-section of a second pipe of the pipeline adjacent to the first pipe. The first and second baffle sections can be shaped as required and are each provided with just one through-opening or with a plurality of throughopenings. The baffle also comprises a connecting section that joins the first and second baffle sections. The connecting section of the baffle is constructed to cooperate with a partition that separates the first pipe from the second pipe when the baffle is assembled on the pipeline.

By using a baffle of this kind use of separate baffles for the first and second pipes or a plurality of pipe cross-sections of the pipeline can be omitted. The number of installed components can be reduced thereby, and this allows advantageous reductions in cost and weight. A baffle of this kind can be particularly advantageously used as a recirculation baffle on a pipeline in an aircraft air conditioning unit which comprises a first pipe for supplying recirculation air and a second pipe for supplying fresh air. A further pipeline that is connected to this pipeline is conventionally used to supply a mixture of air that comprises recirculation air and fresh air into the aircraft cabin. The flow and pressure conditions at the open end of the pipe through which recirculation air flows and at the open end of the pipe through which fresh air flows and therewith the mixing ratio of recirculation air and fresh air in the adjoining pipeline are adjusted by the baffle.

A baffle system of this kind preferably comprises a sealing element that seals the connecting section of the baffle from the partition that separates the first pipe from the second when the baffle is assembled. Correct separation of the first pipe from the second pipe and thus correct operation of the baffle is ensured by the sealing element.

An aircraft air conditioning unit according to the invention comprises a baffle system as described above.

The present invention will be described in more detail hereinafter with reference to the accompanying, schematic figures, in which:

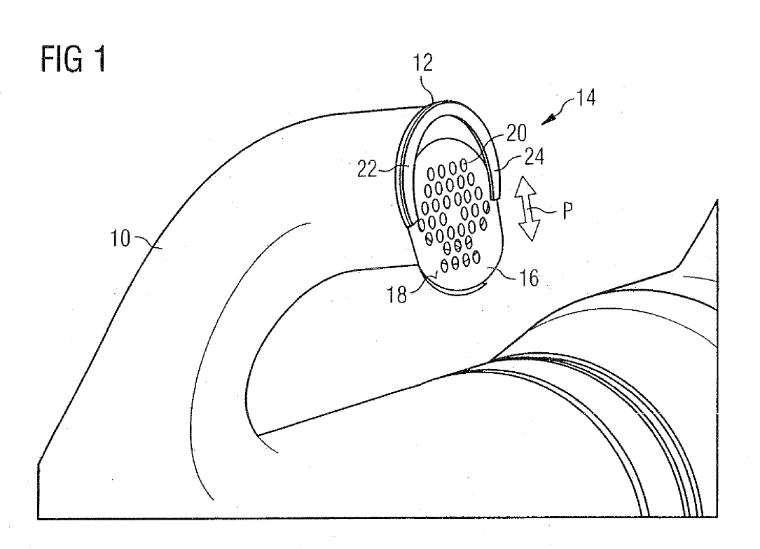

FIG. 1 shows an open end of a pipeline of an aircraft air conditioning unit, on which a first embodiment of a baffle system according to the invention is attached,

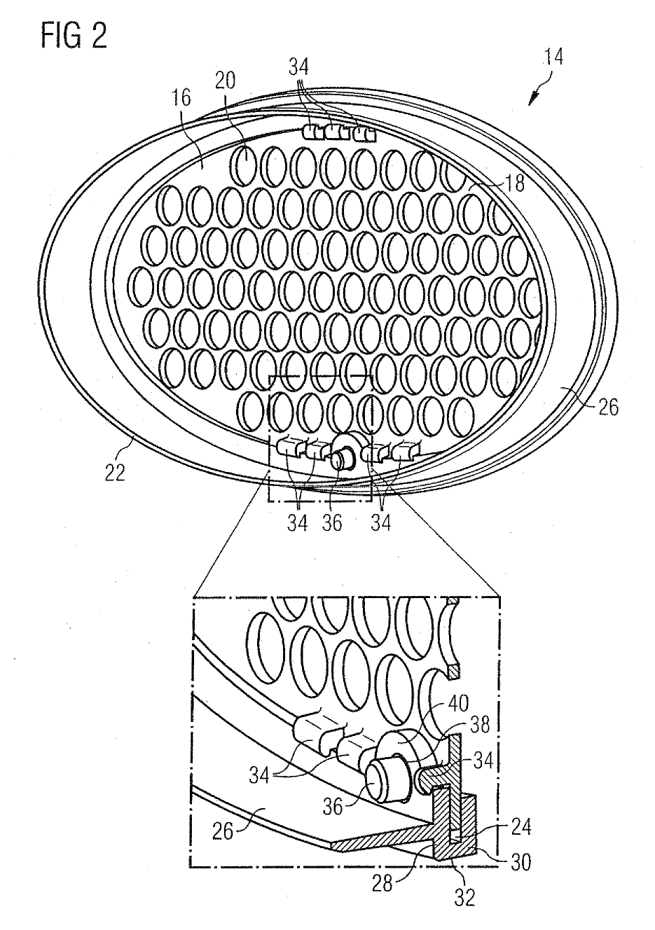

FIG. 2 shows a second embodiment of a baffle system according to the invention with a self-locking mechanism,

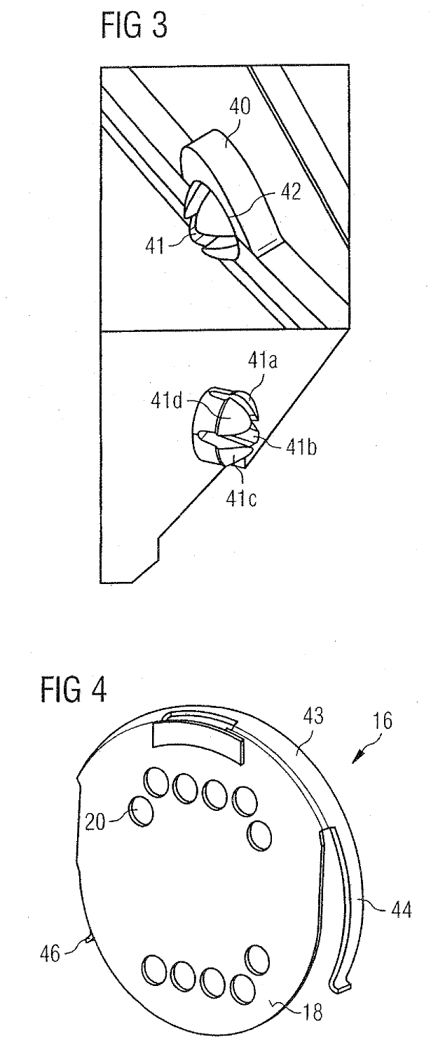

FIG. 3 shows a baffle of a third embodiment of a baffle system according to the invention with an alternative self-locking mechanism,

FIG. 4 shows a baffle of a fourth embodiment of a baffle system according to the invention with a further alternative self-locking mechanism,

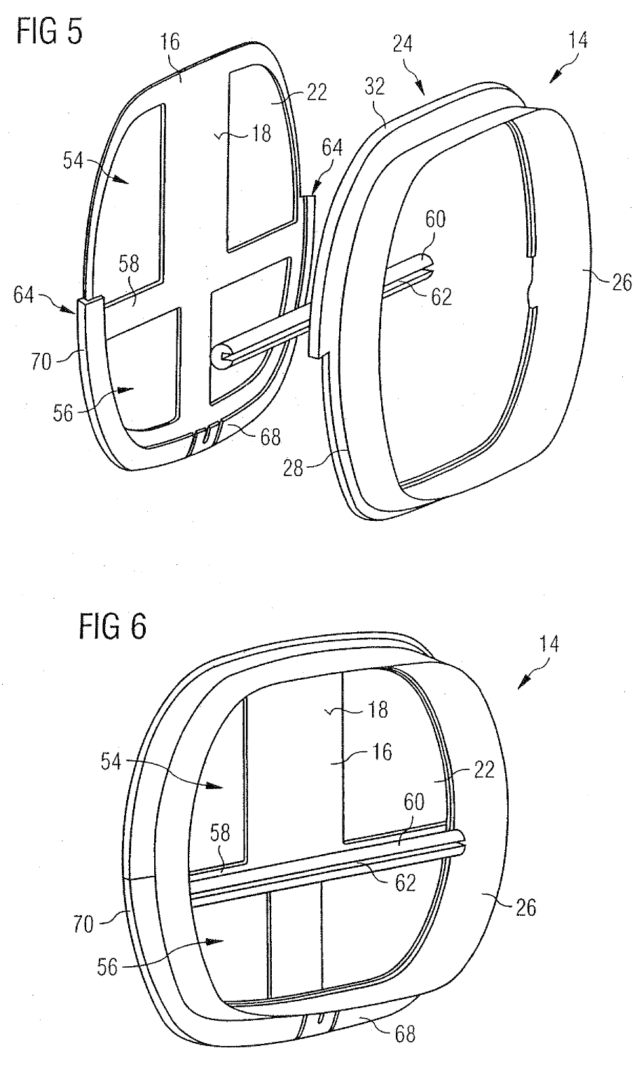

FIG. 5 shows the components of a fifth embodiment of a baffle system according to the invention,

FIG. 6 shows the components of the fifth embodiment of the baffle system according to the invention in the assembled state,

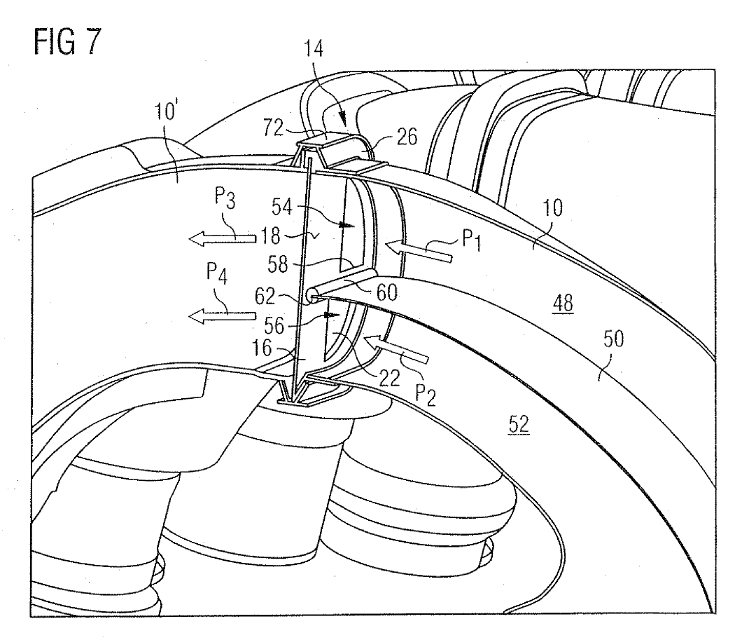

FIG. 7 shows the fifth embodiment of the baffle system according to the invention when assembled in a pipeline.

FIG. 1 shows a pipeline 10 of an aircraft air conditioning unit. The pipeline 10 has an open end 12. The open end 12 of the pipeline 10 is intended for connection to a further pipeline (not shown in FIG. 1).

A baffle system 14 is provided at the open end 12 of the pipeline 10 to control the is volume flow through the pipeline 10 and the further pipeline and to control the pressure in the pipeline 10 and the further pipeline. The baffle system 14 comprises a disc-shaped baffle 16 that has a plurality of through-openings 20 distributed over a baffle face 18. The shape of the baffle 16 is adapted to the cross-sectional shape of the pipeline 10.

The baffle system 14 also comprises a baffle frame 22 that is secured to the open end 12 of the pipeline 10. A receiving groove 24, which extends over a portion of the circumference of the baffle frame 22, is formed on the baffle frame 22. The baffle 16 can consequently be pushed into the receiving groove 24 formed on the baffle frame 22 or be withdrawn from the receiving groove 24 formed on the baffle frame 22, as indicated by arrow P, during assembly or disassembly.

As may best be seen in the baffle system 14 shown in FIG. 2 the baffle frame 22 has a fastening region 26. The fastening region 26 of the baffle frame 22 is adapted to the cross-section of the pipeline 10 and when the baffle frame 22 is assembled on the pipeline 10 rests on an outer circumference of the pipeline 10. When the baffle frame 22 is assembled on the pipeline 10 the fastening region 26 is glued to the pipeline 10.

The receiving groove 24 constructed on the baffle frame 22 for receiving the baffle 16 is formed by a first guide web 28, a second guide web 30 arranged substantially parallel to the first guide web and a connecting web 32 connecting the first guide web 28 to the second guide web 30. The second guide web 30 and the connecting web 32 of the baffle frame 22 extend over only a portion of the circumference of the baffle frame 22 to allow insertion of the baffle 16 into the receiving groove 24. The first guide web 28 of the baffle frame 22 extends over the entire circumference of the baffle frame 22 on the other hand and thereby forms a bearing surface for the baffle 16 inserted in the baffle frame 22.

In the baffle system 14 shown in FIG. 1 the baffle 16 is held by a conventional pipe connecting mechanism, such as a pipe collar or the like, which is used to connect the pipeline 10 to the further pipeline (not shown in FIG. 1), in its position in the baffle frame 22. In contrast thereto the baffle system 14 shown in FIG. 2 can also be attached at an open end 12 of a pipeline 10 which is not intended to be connected to a further pipeline. For fastening the baffle 16 in the baffle frame 22 the baffle 16 and the baffle frame 22 are each provided with a corresponding self-locking mechanism.

In the embodiment shown in FIG. 2 the self-locking mechanism of the baffle 16 comprises a plurality of elastic latching arms 34 which are formed on the baffle 16 and which are constructed to latch with a section of the first guide web 28 of the baffle frame 22 that projects radially inwards from the fastening region 26 of the baffle frame 22 when the baffle 16 is assembled in the baffle frame 22. The baffle 16 is made from a plastics material, so that the latching arms 34 that are made from the same material are sufficiently elastic to produce a secure latched connection between the baffle 16 and the baffle frame 22.

The self-locking mechanism of the baffle 16 also comprises a positioning pin 36 which is formed on the baffle 16 and which is constructed to cooperate with an opening 38 formed on the baffle frame 22 when the baffle 16 is assembled. The opening 38 is formed in an extension 40 which is formed integral with the section of the first guide web 28 of the baffle frame 22 that projects radially inwards from the fastening region 26 of the baffle frame 22. Correct positioning of the baffle 16 in the baffle frame 22 is ensured by the cooperation of the positioning pin 36 formed on the baffle 16 with the opening 38 formed on the baffle frame 22.

In the embodiment shown in FIG. 3 the self-locking mechanism of the baffle 16 by contrast comprises a latching button 41 which is constructed to latch in a latching opening 42 formed on the baffle frame 22 when the baffle 16 is assembled. The latching button 41 has four elastic latching arms 41, 41b, 41c and 41d. Similar to the positioning pin opening 38 the latching opening 42 is formed in an extension 40 of the baffle frame 22 which is formed integral with the section of the first guide web 28 of the baffle frame 22 that projects radially inwards from the fastening region 26 of the baffle frame 22. Cooperation of the latching button 41 with the latching opening 42 provides secure fastening of the baffle 16 in the baffle frame 22.

FIG. 4 shows a baffle 16 of a further embodiment of a baffle system 14 which is provided with an alternatively configured self-locking mechanism. The self-locking mechanism formed on the baffle 16 comprises a baffle flange section 43 which extends over a portion of the circumference of the baffle face 18, substantially perpendicularly to the baffle face 18. Two elastic holding arms 44, 46 extend from the baffle flange section 43. When the baffle system 14 is assembled on the pipeline 10 the baffle flanged portion 43 of the baffle 16 rests on an outer wall of the pipeline 10. The holding arms 44, 46 encompass the pipeline 10, so that the baffle 16 is held in its position in the receiving groove 24 formed on the baffle frame 22 owing to the elastic holding force of the holding arms 44, 46.

FIGS. 5 to 7 show a further example of a baffle system 14. As can best be seen in FIG. 5, the baffle system 14 comprises a baffle frame 22 and a baffle 16. The baffle frame 22 has a similar construction to the baffle frame 22 of the baffle systems 14 shown in FIGS. 1 to 3, but its shape is adapted to the cross-section of the pipeline 10 shown in FIG. 7.

The pipeline 10 comprises a first pipe 48 and a second pipe 52 that is adjacent to the first pipe 48 and is separated therefrom by a partition 50. Fresh air flows through the first pipe 48 in the direction of arrow P₁, whereas recirculation air flows through the second pipe 52 in the direction of arrow P₂. The pipeline 10 is connected to a further pipeline 10′ through which a mixture of fresh air and recirculation air flows in the direction of arrows P₃, P₄.

The baffle 16 of the baffle system 14 is used to adjust the volume flows through the pipeline 10 and the further pipeline 10′ and to adjust the pressure conditions in the pipeline 10 and the further pipeline 10′. The mixing ratio between fresh air and recirculation air in the further pipeline 10′ can also be controlled thereby by the baffle 16. The baffle 16 has a first baffle section 54 and a second baffle section 56. When the baffle system 14 is assembled in the pipeline 10 the first baffle section 54 defines the flow cross-section of the first pipe 48 while the second baffle section 56 defines the flow cross-section of the second pipe 52. The first and second baffle sections 54, 56 are joined together by a connecting section 58.

When the baffle system 14 is assembled in the pipeline 10 the connecting section 58 of the baffle 16 cooperates with the partition 50 that separates the first pipe 48 from the second pipe 52. To seal the connecting section 58 of the baffle 16 from the partition 50 a sealing element 60 is arranged between the connecting section 58 and the partition 50. A groove 62 for receiving the partition 50 that separates the first pipe 48 from the second pipe 52 is formed in the sealing element 60. The sealing element 60 is thereby securely held in its position between the partition 50 and the connecting section 58 of the baffle 16.

As may best be seen in FIGS. 5 and 6, a receiving groove 64 is constructed on the baffle 16 and is formed by a first guide web 66 that extends radially outwards from the baffle face 18, a second guide web 68 arranged parallel to the first guide web 66, and a connecting web 70 connecting the first guide web 66 to the second guide web 68. The first and second guide webs 66, 68 and the connecting web 70 of the baffle 16 extend over a portion of the circumference of the baffle 16.

When assembling the baffle 16 in the baffle frame 22 the baffle 16 is pushed into the receiving groove 24 formed on the baffle frame 22. At the same time the first guide web 28 of the baffle frame 22 is received in the receiving groove 64 formed on the baffle 16. Secure positioning of the baffle 16 in the baffle frame 22 is ensured thereby.

As may be seen in FIG. 7, the pipeline 10 and the further pipeline 10′ are joined together by means of a conventional pipe collar 72. The pipe collar 72 encompasses the baffle system 14 and thus simultaneously provides for fastening of the baffle 16 in the baffle frame 22.

1. Baffle system (14) for use in an air conditioning unit, in particular an aircraft air conditioning unit, comprising:
a baffle frame (22) that is attachable to an open end (12) of a pipeline (10) of the air conditioning unit and
a baffle (16) that defines a flow cross-section of the pipeline (10), wherein a receiving groove (24, 64) is formed on the baffle frame (22) and/or the baffle (16) which extends over only a portion of the circumference of the baffle frame (22) and/or the baffle (16), and wherein the baffle (16) is insertable into the receiving groove (24, 64) formed on the baffle frame (22), and/or a first guide web (28) formed on the baffle frame (22) is insertable into the receiving groove (64) formed on the baffle (16).

2. Baffle system according to claim 1,
characterised in that the baffle frame (22) comprises a fastening region (26) which is adapted to a cross-section of the pipeline (10) and which extends substantially parallel to a pipeline wall when the baffle frame (22) is assembled on the pipeline (10).

3. Baffle system according to claim 1,
characterised in that the receiving groove (24) formed on the baffle frame (22) is formed by the first guide web (28) of the baffle frame (22), a second guide web (30) arranged substantially parallel to the first guide web (28) and a connecting web (32) connecting the first guide web (28) to the second guide web (30).

4. Baffle system according to claim 3,
characterised in that the second guide web (30) and the connecting web (32) of the baffle frame (22) extend over only a portion of the circumference of the baffle frame (22).

5. Battle system according to claim 1,
characterised in that the receiving groove (64) formed on the baffle (16) is formed by a first guide web (66) that extends radially outwards from a baffle face (18), a second guide web (68) arranged substantially parallel to the first guide web (66), and a connecting web (70) connecting the first guide web (66) to the second guide web (68).

6. Baffle system according to claim 5,
characterised in that the first and second guide webs (66, 68) and the connecting web (70) of the baffle (16) extend over only a portion of the circumference of the baffle (16).

7. Baffle system according to claim 1,
characterised in that the baffle (16) and/or the baffle frame (22) is/are equipped with a self-locking mechanism for fastening the baffle (16) to the baffle frame (22).

8. Baffle system according to claim 7,
characterised in that the self-locking mechanism comprises at least one elastic latching arm (34) which is formed on the baffle (16) and which is constructed to latch with the first or the second guide web (28, 30) of the baffle frame (22).

9. Baffle system according to claim 7,
characterised in that the self-locking mechanism comprises a positioning pin (36) which is formed on the baffle (16) and which is constructed to cooperate with an opening (38) formed on the baffle frame (22).

10. Baffle system according to claim 7,
characterised in that the self-locking mechanism comprises at least one elastic latching button (41) which is formed on the baffle (16) and which is constructed to latch in a latching opening (42) formed on the baffle frame (22).

11. Baffle system according to claim 7,
characterised in that the self-locking mechanism comprises a baffle flange section (43) that extends over a portion of the circumference of the baffle (16), and at least one elastic holding arm 44, 46) that extends from the baffle flange section (43).

12. Baffle system according to claim 1, characterised in that the baffle (16) also comprises:
a first baffle section (54) that defines a flow cross-section of a first pipe (48) of the pipeline (10),
a second baffle section (56) that defines a flow cross-section of a second pipe (52) of the pipeline (10), and
a connecting section (58) that joins the first baffle section (54) to the second baffle section (56), wherein the connecting section (58) of the baffle (16) is constructed to cooperate with a partition (50) that separates the first pipe (48) from the second pipe (52) when the baffle (16) is assembled on the pipeline (10).

13. Baffle system according to claim 12,
characterised by a sealing element (60) which, when the baffle (16) is assembled, seals the connecting section (58) of the baffle (16) from the partition (50) that separates the first pipe (48) from the second pipe (52).

14. Aircraft air conditioning unit comprising a baffle system (14) according to claim 1.
